(19) United States
(12) Patent Application Publication
(10) Pub. No.: US 2010/0008378 A1
(43) Pub. Date: Jan. 14, 2010

(54) Ethernet Controller Implementing a Performance and Responsiveness Driven Interrupt Scheme

(75) Inventor: Chung Chen Luan, Saratoga, CA (US)

Correspondence Address: PATENT LAW GROUP LLP, 2635 NORTH FIRST STREET, SUITE 223, SAN JOSE, CA, 95134, US

(73) Assignee: MICREL, INC., San Jose, CA (US)

(21) Appl. No.: 12/169,499

(22) Filed: Jul. 8, 2008

(51) Int. Cl. H04L 12/56

(52) U.S. Cl. 370/415

(57) ABSTRACT

A method of generating frame receive interrupts in an Ethernet controller including receiving incoming data frames and storing data frames into a receive queue, monitoring the number of received data frames, and when the number of received data frames exceeds a first threshold, generating a frame receive interrupt. In another embodiment, the method further includes monitoring the amount of received data stored in the receive queue and generating a frame receive interrupt when the first threshold is exceeded and when the amount of received data stored in the receive queue exceeds a second threshold. In yet another embodiment, the method further includes monitoring the time duration of the data frames stored in the receive queue, and generating a frame receive interrupt when the number of received data frames exceeds the first threshold or when the time duration of the data frames stored in the receive queue exceeds a third threshold.

### FIELD OF THE INVENTION

The invention relates to Ethernet controllers and, in particular, to an Ethernet controller implementing a performance and responsiveness driven interrupt scheme where system interrupts are generated under predefined conditions to reduce the system interrupts being generated and thereby improve the performance of the host processor coupled to the Ethernet controller.

### DESCRIPTION OF THE RELATED ART

Ethernet Controllers are incorporated in networking devices to provide network communication functions. For example, cable or satellite set-top boxes or voice over IP adapters incorporate Ethernet controllers for communicating with a data network, such as a local area network (LAN) implemented using the IEEE 802.3 standards. In general, an Ethernet controller communicates with a host processor in a networking device to provide received data and to transmit outgoing data. Typically, the Ethernet controller communicates with the host processor via system interrupts. More specifically, a host processor working cooperatively with an Ethernet controller relies on interrupt service routines (ISR) to retrieve incoming date frames or transmit outgoing data frames.

An interrupt service routine, also referred to as an interrupt handler, is a software routine in an operating system whose execution is triggered when an interrupt is received by the operating system. An interrupt is a signal generated by hardware that is communicated to the operating system to trigger the execution of codes in software associated with the specific type of interrupt. In an Ethernet controller, system interrupts are triggered for various conditions, such as when a data frame is received into the receive queue (RXQ). The host processor, upon receipt of the system interrupt, must service the interrupt by executing software code for the specific system interrupt. To service an interrupt, the host processor must save its current state of execution (commonly referred to as “leaving or entering the software stack”) and begin execution of the ISR associated with the interrupt. Conventional Ethernet controllers trigger system interrupts for each data frame received into the receive queue (RXQ).

The system performance of the networking device is often negatively impacted due to the overhead for the interrupt service routines (ISR). The necessities of leaving or entering the software stack constantly to service the interrupts from the Ethernet controllers slow down the performance of the networking device.

### SUMMARY OF THE INVENTION

According to one embodiment of the present invention, a method of generating frame receive interrupts in an Ethernet controller including receiving incoming data frames and storing data frames into a receive queue; monitoring the number of received data frames; and when the number of received data frames exceeds a first threshold, generating a frame receive interrupt.

According to another aspect of the present invention, the method further includes monitoring the amount of received data stored in the receive queue; and when the number of received data frames exceeds the first threshold and the amount of received data stored in the receive queue exceeds a second threshold, generating a frame receive interrupt.

According to yet another aspect of the present invention, the method further includes monitoring the time duration of the data frames stored in the receive queue; and when the number of received data frames exceeds the first threshold or when the time duration of the data frames stored in the receive queue exceeds a third threshold, generating a frame receive interrupt.

The present invention is better understood upon consideration of the detailed description below and the accompanying drawings.

### BRIEF DESCRIPTION OF THE DRAWINGS

FIG. 1 is a block diagram of an Ethernet controller in which the performance and responsiveness driven interrupt scheme can be implemented according to one embodiment of the present invention.

FIG. 2 is a flow chart illustrating the operation of the performance and responsiveness driven interrupt scheme according to one embodiment of the present invention.

### DETAILED DESCRIPTION OF THE PREFERRED EMBODIMENTS

In accordance with the principles of the present invention, an Ethernet controller implements a performance and responsiveness driven interrupt scheme where system interrupts are triggered under predefined conditions to reduce the number of interrupts being triggered, thereby improving the performance of the host processor coupled to the Ethernet controller. More specifically, conventional Ethernet controllers generate a system interrupt for every data frame received and the host processor coupled thereto has to service each interrupt received, resulting in a high operating system overhead. In accordance with the performance and responsiveness driven interrupt scheme of the present invention, the Ethernet controller triggers an interrupt under certain predefined conditions, such as the number of data frames received, the amount or size of data received or the elapsed time of the data frame received. As a result, the overhead for interrupt service routine (ISR) due to leaving or entering the software stack in response to an interrupt is minimized because interrupts are not generated for each data frame. Furthermore, more frame data can be transferred to the memory of the host processor in every ISR visit as opposed to transferring one data frame at a time in the conventional operation.

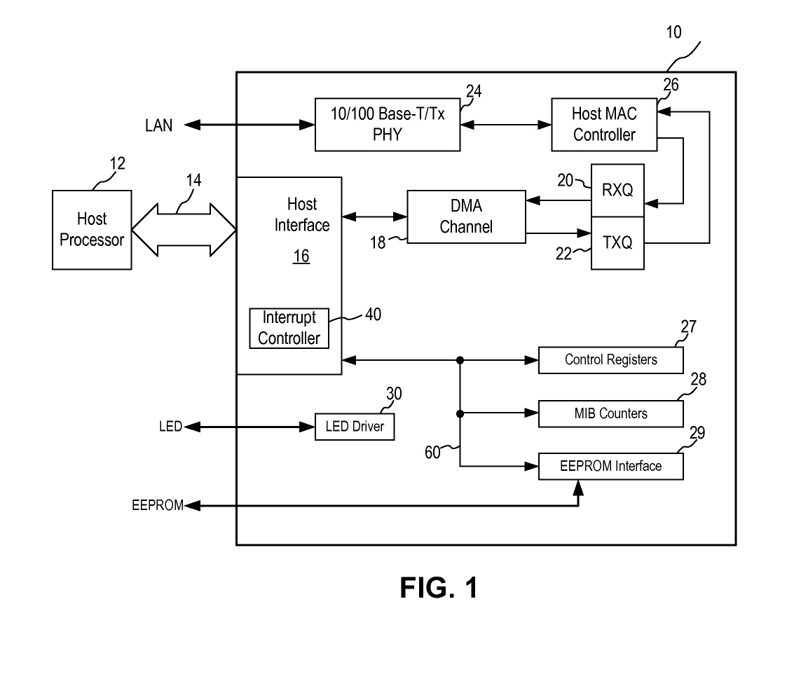

FIG. 1 is a block diagram of an Ethernet controller in which the performance and responsiveness driven interrupt scheme can be implemented according to one embodiment of the present invention. Referring to FIG. 1, an Ethernet controller 10 includes a host interface block 16 for communicating with a host processor 12, a physical layer transceiver (PHY) 24 for communicating over the physical medium, and a host media access control (MAC) controller 26. For Fast Ethernet applications, the PHY block 24 is implemented as a 10/100 Base-T/Tx physical layer transceiver. Ethernet controller 10 also includes a buffer memory for storing the transmit and receive data. More specifically, the buffer memory is implemented as a receive queue (RXQ) 20 and a transmit queue (TXQ) 22. To allow the host processor 12 to access the receive and transmit data stored in the receive queue and the transmit queue, Ethernet controller 10 includes a direct memory access (DMA) channel 18 whereby the host processor 12 accesses the receive and transmit data through the host interface 16 and the DMA channel 18. In other implementations, other circuits and methods for accessing the receive queue and transmit queue can be used and the use of DMA channel 18 in the present embodiment is illustrative only.

Finally, Ethernet controller 10 includes control registers 27 and management information base (MIB) counters 28 for storing control information. An EEPROM interface block 29 may be included to support an optional external EEPROM in some applications. Registers 27-29 communicate with host interface 16 via an internal data bus 60. Ethernet controller 10 may also include an LED driver 30 for driving an LED indicator where applicable.

In Ethernet controller 10, host interface block 16 incorporates an interrupt controller 40 for generating system interrupts, such as the frame receive interrupts, that are communicated to host processor 12 to cause the host processor to execute the respective interrupt service routines.

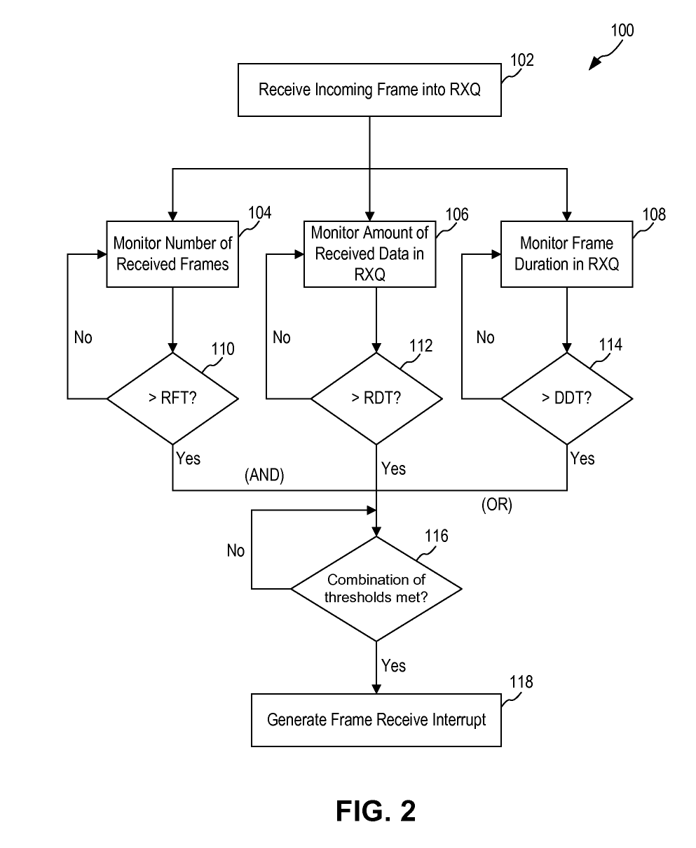

FIG. 2 is a flow chart illustrating the operation of the performance and responsiveness driven interrupt scheme according to one embodiment of the present invention. In the present embodiment, the performance and responsiveness driven interrupt scheme triggers an interrupt based on three predefined conditions: how many frames has been received, how much data has been received, or how much time duration has passed since the data frame was received. The performance and responsiveness driven interrupt scheme of the present invention operates to generate system interrupts in an intelligent manner so as to reduce the overhead burden at the host processor for servicing the interrupts. More specifically, the performance and responsiveness driven interrupt scheme of the present invention avoids triggering interrupts for single received frame of large size or small size and instead triggers interrupts only for sufficient number of data frames received and sufficient amount of data received. Accordingly, the performance and responsiveness driven interrupt scheme of the present invention enables multiple data frames to be transmitted for each system interrupt, increasing the efficiency of the host processor.

Referring to FIG. 2, method 100 illustrates one embodiment of the performance and responsiveness driven interrupt scheme of the present invention where three operating conditions are used as the thresholds for triggering a frame receive interrupt. Method 100 starts by receiving incoming data frames into the receive queue (RXQ) (step 102). Method 100 then proceeds to determine if one of three operating conditions are met.

At step 104, method 100 monitors the number of received data frames. The number of received data frames is compared to a received frame thresholds (RFT) (step 110). If the RFT threshold is not met, method 100 continues to monitor the number of received frames (step 104) until the number of received data frames exceeds the predefined RFT threshold. When the RFT threshold is met (step 116), method 100 proceeds to generate a frame receive interrupt (step 118) where the host processor is able to execute an ISR for receiving multiple data frames. Multiple frame transfer ensures efficiency particularly when most of the frames received have frame size above a medium size. In this manner, a large number of data frames and a large amount of data can be transferred to the memory in the host processor through burst access.

At step 106, method 100 monitors the amount of received data in the receive queue (RXQ). In some cases, the incoming data frames may consist of data frames of small frame size. Because the RFT threshold is met whenever sufficient number of frames are received, the RFT threshold may be frequently triggered when there are numerous incoming data frames all of small frame size. To avoid ISR visits for small size data frames received, method 100 monitors the amount of received data stored in the RXQ (step 106) and uses a received data threshold (RDT) (step 112) to determine if a sufficient amount of data has been received in the RXQ so that the frame receive interrupt should be triggered. The received data threshold (RDT) assures that multiple data frames with enough accumulated data are received before the frame receive interrupt is asserted.

In the present embodiment, a combination of RFT and RDT is used to trigger the frame receive interrupt. That is, both the RFT and the RDT thresholds have to be met (an “AND” condition) for the frame receive interrupt to be generated. In this manner, method 100 generates a frame receive interrupt only when sufficient number of data frames are received and sufficient amount of data are stored in the RXQ. Thus, method 100 ensures efficient use of frame receive interrupts.

At step 108, method 100 monitors the time duration of the data frame received and being stored in the RXQ. When both the RFT and RDT thresholds are used, there may be situations where a number of data frames of small or medium frame sizes have been received but one of the RFT and RDT thresholds is not met so that the frame receive interrupt is not generated. As a result, the received data frames may stay in the RXQ and remain unread for a long period of time because the host processor is not yet informed. To avoid frame stagnation and delay the host processor's response to the received frames, method 100 monitors the elapsed time of the data frames in the RXQ. The time duration is compared with a data duration threshold (DDT) (step 114) to determine if the duration time threshold has been exceeded. In this manner, when the data frames have bee received for a sufficiently long time, a frame receive interrupt is triggered (step 118) regardless of the number of data frames received or the amount of data in the RXQ. Thus, the DDT threshold is an OR condition with the AND combination of the RFT and RDT thresholds.

In other embodiments, different combinations of the RFT, RDT and DDT threshold conditions can be used to provide a flexible, yet efficient interrupt scheme to meet the various network traffic patterns. The AND/OR combination described with reference to FIG. 2 is illustrative only.

Returning to FIG. 1, in one embodiment of the present invention, the logic circuitry for implementing method 100 is incorporated in interrupt controller 40 in host interface block 16. In one embodiment, a RFT counter is used to monitor the number of received data frames where the counter is incremented for every data frame completely received. A RFT comparator is used to compare the RFT counter value to the RFT threshold. Similarly, a RDT counter is used to monitor the amount of data received in the RXQ and a RDT comparator is used to compare the RDT counter to the RDT threshold. Finally, a duration counter is used to monitor the RXQ duration of the received data and a DDT comparator is used to determine when the duration exceeds the DDT threshold. In one embodiment, the duration counter is started soon after the first frame is received and is incremented every 1 μs.

By using one or more or a combination of the RFT, RDT and DDT threshold conditions, Ethernet controller 10 can generate frame receive interrupts efficiently to improve the performance of the host processor coupled thereto. More specifically, the RFT threshold is used to facilitate reading of multiple frames for each ISR visit, the RDT threshold is used to ensure that enough frame data are in RXQ before an ISR visit, and finally, the DDT threshold is used to assure that received frames in RXQ will be read and processed in time. Any one or more of the three threshold conditions can be used to generate the frame receive interrupts and furthermore, any AND/OR combination of two or more of the three threshold conditions can be used depending on the network traffic pattern.

In one embodiment, a small frame size refers to a frame of 64 bytes to 127 bytes, a medium frame size refers to a frame of 128 bytes to 511 bytes, and a large frame size refers to a frame of 512 bytes to 2000 bytes. One of ordinarily skill in the art would appreciate that the frame sizes are relative and the exact values are only pertinent to the communication system in which the Ethernet controller is being applied.

The above detailed descriptions are provided to illustrate specific embodiments of the present invention and are not intended to be limiting. Numerous modifications and variations within the scope of the present invention are possible. The present invention is defined by the appended claims.

I claim:

1. A method of generating frame receive interrupts in an Ethernet controller comprising:
receiving incoming data frames and storing data frames into a receive queue;
monitoring the number of received data frames; and
when the number of received data frames exceeds a first threshold, generating a frame receive interrupt.

2. The method of claim 1, further comprising:
monitoring the amount of received data stored in the receive queue; and
when the number of received data frames exceeds the first threshold and the amount of received data stored in the receive queue exceeds a second threshold, generating a frame receive interrupt.

3. The method of claim 1, further comprising:
monitoring the time duration of the data frames stored in the receive queue; and
when the number of received data frames exceeds the first threshold or when the time duration of the data frames stored in the receive queue exceeds a third threshold, generating a frame receive interrupt.

4. The method of claim 2, further comprising:
monitoring the time duration of the data frames stored in the receive queue; and
when the number of received data frames exceeds the first threshold and the amount of received data stored in the receive queue exceeds a second threshold, or when the time duration of the data frames stored in the receive queue exceeds a third threshold, generating a frame receive interrupt.

5. An Ethernet controller having a host interface for coupling to a host processor, a physical layer transceiver for coupling to a data network for receiving incoming data frames and a receive queue for storing incoming data frames, the Ethernet controller comprising:
an interrupt controller for monitoring the number of received data frames and generating a frame receive interrupt when the number of received data frames exceeds a first threshold.

6. The Ethernet controller of claim 5, wherein the interrupt controller further monitors the amount of received data stored in the receive queue and generates a frame receive interrupt when the number of received data frames exceeds the first threshold and the amount of received data stored in the receive queue exceeds a second threshold.

7. The Ethernet controller of claim 5, wherein the interrupt controller further monitors the time duration of the data frames stored in the receive queue and generates a frame receive interrupt when the number of received data frames exceeds the first threshold or when the time duration of the data frames stored in the receive queue exceeds a third threshold.

8. The Ethernet controller of claim 6, wherein the interrupt controller further monitors the time duration of the data frames stored in the receive queue and generates a frame receive interrupt when the number of received data frames exceeds the first threshold and the amount of received data stored in the receive queue exceeds a second threshold, or when the time duration of the data frames stored in the receive queue exceeds a third threshold.
